(19) United States
(12) Patent Application Publication
(10) Pub. No.: US 2012/0013831 A1
(43) Pub. Date: Jan. 19, 2012

(54) PROCESS OF PREPARING AN ANISOTROPIC MULTILAYER USING PARTICLE BEAM ALIGNMENT

(75) Inventors: Owain Llyr Parri, Hampshire (GB); Oleg Yaroshchuk, Kyiv (UA); Ruslan Kravchuk, Kyiv (UA)

(73) Assignee: MERCK PATENT GMBH, DARMSTADT (DE)

(21) Appl. No.: 13/258,492

(22) PCT Filed: Mar. 11, 2010
(86) PCT No.: PCT/EP10/01500

§ 371 Date: Sep. 22, 2011

(30) Foreign Application Priority Data
Mar. 26, 2009 (EP) 09004332.4
Apr. 2, 2009 (EP) 09004886.9

(51) Int. Cl. G02F 1/1335; B29D 11/00

(52) U.S. Cl. 349/117; 349/193; 216/24

(57) ABSTRACT

The invention relates to a process of preparing a multilayer comprising two or more anisotropic layers with different optical axes by using a particle beam etching technique, to a multilayer obtained by said process, to the use of such a multilayer as optical compensator or retarder in optical and electrooptical devices, and to devices comprising such a multilayer.

### FIELD OF THE INVENTION

The invention relates to a process of preparing a multilayer comprising two or more anisotropic layers with different optical axes or alignment directions, such as layers of liquid crystals (LCs) or reactive mesogens (RMs), by using a particle beam etching technique, to a multilayer obtained by said process, to the use of such a multilayer as optical compensator or retarder in optical and electrooptical devices, and to devices comprising such a multilayer.

### BACKGROUND AND PRIOR ART

Optical retarders (also referred to as optical retardation films) are used as separate elements of optical schemes or as integrated parts of liquid crystal displays (LCD). In the latter case they are often also referred to as compensators or compensation films. For good performance, optical retarders often have a multilayer structure consisting of two or more superposed single retarder layers. The optical retarders typically consist of a birefringent material, such as crystal plates or polymer films with optical anisotropy induced via stretching, shearing, bulk photoalignment or surface alignment. The latter procedure relates to films of LC molecules, for example LC polymers or RMs.

Various types of optical retarders are known. For example, an “A film” (or A-plate) is an optical retarder utilizing a layer of uniaxially birefringent material with its extraordinary axis oriented parallel to the plane of the layer, a “C film” (or C-plate) is an optical retarder utilizing a layer of uniaxially birefringent material with its extraordinary axis oriented perpendicular to the plane of the layer, and an “O film” (or O-plate) is an optical retarder utilizing a layer of uniaxially birefringent material with its extraordinary axis tilted at an angle to the plane of the layer.

However, conventional optical retarders often show undesired chromaticity, which is a general property of birefringent elements. When a polarized polychromatic beam passes through a birefringent medium, the constituent spectral components gain different phase retardation and so different polarization state. When the beam further passes through an analyzer, the intensities of its spectral components differently change, that changes color gamut of the transmitted light. The factors contributing to the wavelength sensitivity, or chromaticity, of a retarder are: (1) dispersion, i.e., wavelength dependence of optical birefringence, and (2) the explicit inverse wavelength dependence of retardation due to the wavelength dependent optical path length.

The chromaticity places limitations on the spectral operation range of birefringent optical elements. The wavelength dependence can be reduced by replacing single birefringent film/plate with a stack of these films/plates. The principle behind an achromatic compound retarder is that a stack of birefringent films/plates with adjusted retardence and orientation may behave as a simple one film/plate retarder, but with wavelength insensitive retardence. For example, a typical achromatic quarter wave retardation film (AQWF) can be obtained by laminating a film approximating to a quarter wave retarder (QWF) and a film approximating to a half wave retarder (HWF) such that their slow axes are approximately oriented at an angle of 60° relative to each other within the film plane. The exact values for the retardation of the two retarders depend on the angle of lamination. However, the costs of manufacturing of such AQWF films are high because the two retarders cannot be laminated together at the desired angle in a cost effective manner.

U.S. Pat. No. 7,169,447 describes an AQWF consisting of a QWF and a HWF, each of which consists of a layer of polymerised reactive mesogens, wherein the slow axes of the two films are oriented at an angle of 60° relative to each other within the film plane. To achieve this specific geometry each film is prepared separately on a substrate that has been rubbed uniaxially in a specific direction to induce the desired orientation. The rubbing direction of the substrate for the QWF and the rubbing direction of the substrate for the HWF correspond to the orientation direction of the slow axis of the respective film. The two films are then subsequently laminated together to form an AQWF.

It is also possible for example to use a stack of two crossed positive A films or two crossed O films, wherein the slow axes of the two films (or, in case of the O plate, the projection of the slow axis into the film plane) are oriented at an angle of 90° relative to each other within the film plane, as a negative C film for the compensation of LCDs (see Schadt et al., SID'99, and M. Schadt et al., Journal of the SID 11/3, 2003 519). The chromaticity shift of LCDs with such a film is considerably smaller than that of conventional film of discotic LCs widely used in the LCD industry. In Schadt et al., Jpn. J. Appl. Phys., 34, L764-767 (1995) it is described to prepare such films from reactive mesogens that are aligned by photoalignment techniques, and wherein both single RM films are coated on one substrate. However, the two single RM layers are separated by the layer of photoaligning polymer that is required to induce alignment of the RMs.

Thus, up-to-date techniques for the preparation of stacked retarders require a lamination process and/or the use of additional alignment layers. However, these additional processes and components increase the prime costs of the products. Besides, the insertion of intermediate layers between RM films can worsen the characteristics of the retarders, for example by increasing the scattering and reflection losses. Also, the wet coating of an alignment layer on the RM sublayer may affect its optical uniformity.

A possible solution to overcome the above-mentioned drawbacks could be the direct deposition of a second coated retarder film made of RMs on top of a first retarder film made of RMs. However, RM films are usually strongly orientationally coupled. As a result the first RM film will act as an alignment layer for the second RM film. For example, in the case of two RM A-plate films being coated onto each other, if the surface of the first film is not subjected to alignment treatment, the molecules in the second RM film are usually effectively orientated by the RM molecules on the surface of the first RM layer, and therefore the slow axes of both films will be largely parallel. Moreover, as will be shown below even conventional rubbing procedures usually cannot decouple the alignment in these films, so that the alignment force of the first RM film overcomes the rubbing effect. Besides, rubbing or other methods of mechanical treatment have several disadvantages, such as surface damaging, charging and dusting, complexity of patterning, and insufficient alignment uniformity on a microscopic level. Therefore, an effective method to control alignment in the second RM film provided on top of the first RM film is needed.

It is therefore an aim of the present invention to provide an improved method for preparing stacks or multilayers of LC or RM films, which consist of two or more sublayers of aligned LCs or RMs coated directly on top of each other, wherein the different sublayers have different alignment direction. The method should provide uniform and stable alignment in each sublayer, without the need of rubbing techniques or additional alignment layers between the LC or RM sublayers. In addition, the method should be simple and cost-effective, be suitable especially for mass production, and should not have the drawbacks of the prior art methods described above. Other aims of the present invention are immediately evident to the person skilled in the art from the following detailed description.

The inventors have found that these aims can be achieved by providing a method as claimed in this invention. In particular, this method provides a second alignment direction in a second LC or RM layer provided on top of a first LC or RM layer having a first alignment direction, by subjecting the surface of the first layer, which is to be coated with the second layer, to a particle beam etching process. The etching process is carried out such that it imparts to the surface of the first layer an alignment force in a direction that is different from the alignment direction of the LCs or RMs in said first layer. It was surprisingly found that the alignment force that is enacted to the LCs or RMs of the second layer by the particle beam (which is resulting from the anisotropic etching treatment of the first layer), is so strong that it overcomes the intrinsic alignment force of the LCs or RMs of the first layer. This can be achieved by using identical or different LC or RM materials in the first and the second layer.

Particle beam etching has been disclosed in prior art as an effective technique for the alignment of LCs or RMs, for example in WO 2008/028553 A1; O. Yaroshchuk, R. Kravchuk, O. Parri et al., Journal of the SID 16/9, 905-909 (2008); and O. Yaroshchuk, R. Kravchuk, O. Parri et al., SID Digest 2007, 694-697.

However, it was hitherto not known or suggested that this technique can also be used to prepare several LC or RM layers on top of each other, wherein the single layers are orientationally decoupled from each other and can be aligned into different directions. In particular it was not known or suggested that the alignment force resulting from plasma treatment of the first layer could overcome its natural alignment force, so that a second layer coated onto the first layer can have an alignment direction that is different from the first layer.

Moreover, the particle beam method described in this invention can also generate LC alignment on other anisotropic substrates such as crystal plates, stretched or photoaligned polymeric films, aligned LC polymers, overcoming their natural alignment force. This allows to prepare multiple anisotropic films by combination of LC films with films of other anisotropic materials.

### SUMMARY OF THE INVENTION

The invention relates to a process of preparing a multilayer consisting of at least one first anisotropic layer having an optical axis, and at least one second anisotropic layer of liquid crystal (LC) material which is optionally an LC polymer or a polymerised LC material, said process comprising the following steps

A) providing a first anisotropic layer having an optical axis,
B) exposing the surface of said first layer to a beam of moderately accelerated particles, preferably having a predominated particle energy of 100-10,000 eV, such as ions or plasma, thereby providing surface etching and inducing an anchoring direction on said surface of said first layer,
C) providing a layer of LC material onto said exposed surface of said first layer,
D) optionally polymerising said second layer of LC material, wherein the optical axis of said first layer, or the projection of the optical axis of said first layer into the plane of said first layer, forms an angle with the in-plane anchoring direction on said surface of said first layer, or the projection of the anchoring direction on said surface of said first layer, induced by the particle beam exposure that is different from 0°.

The first anisotropic layer is preferably a crystal plate, a film of aligned and solidified LC material like for example a dried, vitrified or polymerized LC compound or mixture, a stretched, sheared or photoaligned polymeric layer, or a layer of a liquid crystal (LC) polymer.

The invention further relates to a multilayer obtained by a process as described above and below.

The invention further relates to a multilayer with more than two layers, preferably obtained by a process as described above and below, wherein the additional layers are preferably deposited by additional steps B), C) and optionally D).

The invention further relates to the use of a multilayer as described above and below as optical retarders or compensators in optical or electrooptical devices.

The invention further relates to an optical or electrooptical device comprising a multilayer as described above and below.

Said optical and electrooptical devices include, without limitation electrooptical displays, liquid crystal displays (LCDs), polarisers, compensators, beam splitters, reflective films, alignment films, colour filters, holographic elements, hot stamping foils, coloured images, decorative or security markings, LC pigments, adhesive layers, non-linear optic (NLO) devices, and optical information storage devices.

### TERMS AND DEFINITIONS

The term “particle beam” means a beam of ions, neutrals, radicals, electrons, or mixtures thereof such as plasma. Hereafter, the term particle beam will be mainly used to denote beams of accelerated ions or plasma.

The term “plasma beam” or “accelerated plasma beam” means a particle beam formed immediately in a glow discharge and pushed out of the discharge area by the electric field, usually, by the high anode potential.

The term “ion beam” is used to denote ion flux extracted from the glow discharge, commonly by the system of grids. In this case, glow discharge area and formed beam are spatially separated.

The term “particle energy” means the kinetic energy of individual particles. Depending on the particle source, particles have narrow or broad energy distribution. The particles' energy corresponding to a maximum of energy distribution will be called “predominated particles energy”. In case of very narrow energy distribution each particle has energy equal to the predominated energy.

The term “beam of moderately accelerated particles/ions/plasma” means a beam of accelerated particles as defined above having a predominated energy 100-10000 eV, preferably 100-5000 eV, very preferably 400-1000 eV.

The term “anode layer source” means a particle beam source from the family of Hall sources generating fluxes of moderately accelerated plasma with a broad distribution of particle's energy, the maximal particle energy being considerably lesser than 10,000 eV and a maximum of energy distribution, i.e., predominated particle energy, at ⅔ of the maximal energy. This source is usually used for particle beam etching and sputtering deposition. The details of construction of this source, working principle and operation parameters can be found in V. Zhurin, H. Kaufman, R. Robinson, Plasma Sources Sci. Technol., 8, p. 1, 1999, in WO 2004/104862 A1 and in WO 2008/028553 A1.

The term “non-reactive particles” means particles that do not react (or do only poorly react) with other particles. Having sufficient acceleration, these particles cause physical etching of a substrate rather than film deposition. The gases providing non-reactive particles are referred to as “non-reactive” gases. Examples of these gases are rare gases such as Ar, Xe, Kr etc.

The term “liquid crystal” relates to materials having liquid crystalline mesophases in some temperature ranges (thermotropic LCs) or in some concentration ranges in solutions (lyotropic LCs). They obligatorily contain mesogenic compounds.

The terms “mesogenic compound” and “liquid crystal compound” mean a compound comprising one or more calamitic (rod- or board/lath-shaped) or discotic (disk-shaped) mesogenic groups. The term “mesogenic group” means a group with the ability to induce liquid crystalline phase (or mesophase) behaviour.

The compounds comprising mesogenic groups do not necessarily have to exhibit an LC mesophase themselves. It is also possible that they show LC mesophases only in mixtures with other compounds, or when the mesogenic compounds or materials, or the mixtures thereof, are polymerised. This includes low-molecular-weight non-reactive LC compounds, reactive or polymerisable LC compounds, and LC polymers.

A calamitic mesogenic group is usually comprising a mesogenic core consisting of one or more aromatic or non-aromatic cyclic groups connected to each other directly or via linkage groups, optionally comprising terminal groups attached to the ends of the mesogenic core, and optionally comprising one or more lateral groups attached to the long side of the mesogenic core, wherein these terminal and lateral groups are usually selected e.g. from carbyl or hydrocarbyl groups, polar groups like halogen, nitro, hydroxy, etc., or polymerisable groups.

The term “reactive mesogen” means a polymerisable mesogenic or liquid crystal compound, preferably a monomeric compound. These compounds can be used as pure compounds or as mixtures of reactive mesogens with other compounds functioning as photoinitiators, inhibitors, surfactants, stabilizers, chain transfer agents, non-polymerisable compounds, etc.

Polymerisable compounds with one polymerisable group are also referred to as “monoreactive” compounds, compounds with two polymerisable groups as “direactive” compounds, and compounds with more than two polymerisable groups as “multireactive” compounds. Compounds without a polymerisable group are also referred to as “non-reactive” compounds.

The term “thin film” means a film having a thickness in the range from several nm to several μm, in case of LCs or RMs usually in the range from 0.5 to 100 μm, preferably from 0.5 to 10 μm.

The terms “film” and “layer” include rigid or flexible, self-supporting or free-standing films with mechanical stability, as well as coatings or layers on a supporting substrate or between two substrates.

The term “director” is known in prior art and means the preferred orientation direction of the long molecular axes (in case of calamitic compounds) or short molecular axes (in case of discotic compounds) of the LC or RM molecules. In case of uniaxial ordering of such anisotropic molecules, the director is the axis of anisotropy.

The term “alignment” or “orientation” relates to alignment (orientational ordering) of anisotropic units of material such as small molecules or fragments of big molecules in a common direction named “alignment direction”. In an aligned layer of LC or RM material the LC director coincides with the alignment direction so that the alignment direction corresponds to the direction of the anisotropy axis of the material.

The terms “uniform orientation” or “uniform alignment” of an LC or RM material, for example in a layer of the material, mean that the long molecular axes (in case of calamitic compounds) or the short molecular axes (in case of discotic compounds) of the LC or RM molecules are oriented substantially in the same direction. In other words, the lines of LC director are parallel.

Throughout this application, the alignment of LC or RM layers, unless stated otherwise, is uniform alignment.

The term “homeotropic orientation/alignment”, for example in a layer of an LC or RM material, means that the long molecular axes (in case of calamitic compounds) or the short molecular axes (in case of discotic compounds) of the LC or RM molecules are oriented substantially perpendicular to the plane of the layer.

The term “planar orientation/alignment”, for example in a layer of an LC or RM material, means that the long molecular axes (in case of calamitic compounds) or the short molecular axes (in case of discotic compounds) of the LC or RM molecules are oriented substantially parallel to the plane of the layer.

The term “tilted orientation/alignment”, for example in a layer of an LC or RM material, means that the long molecular axes (in case of calamitic compounds) or the short molecular axes (in case of discotic compounds) of the LC or RM molecules are oriented at an angle θ (“tilt angle”) between 0 and 90° relative to the plane of the layer.

The term “splayed orientation/alignment” means a tilted orientation as defined above, wherein the tilt angle varies in the direction perpendicular to the film plane, preferably from a minimum to a maximum value.

The average tilt angle θₐᵥₑ is defined as follows

$${θ}_{ave} = \frac{{\sum }_{{d}^{′} = 0}^{d} {θ}^{′} ( {d}^{′} )}{d}$$

wherein θ′(d′) is the local tilt angle at the thickness d′ within the layer, and d is the total thickness of the layer.

The tilt angle in a splayed layer hereinafter is given as the average tilt angle θₐᵥₑ, unless stated otherwise.

The term “anchoring direction” means the direction of alignment that a first anisotropic layer will impart to the LC or RM molecules of a second layer provided onto said first layer. The projection of this direction on the plane of the first anisotropic layer is referred to as the “in-plane” anchoring direction. Hereinafter intrinsic anchoring direction and induced anchoring direction will be considered.

The “intrinsic anchoring direction” means the direction of LC alignment provided by an anisotropic film or plate by itself, which is imparted to a layer of LC molecules provided on said layer or plate. In case of the present invention, if the first layer comprises or consists of LC or RM molecules, the intrinsic in-plane anchoring direction of the first layer that is imparted to the second layer depends on the type of LC or RM molecules of the first and second layer. If the first and the second layer comprise or consist of LC or RM molecules of the same type (either calamitic or discotic), the intrinsic in-plane anchoring direction imparted to the LC or RM molecules of the second layer provided onto the first layer is usually parallel to the alignment direction of the LC or RM molecules in the first layer. If the first and the second layer comprise or consist of LC or RM molecules of different type (one calamitic and the other discotic), the intrinsic in-plane anchoring direction imparted to the second layer provided on the first layer is usually perpendicular to the alignment direction in the first layer. In case of first layers with tilted alignment, the intrinsic in-plane anchoring direction is given by the projection of said alignment direction into the layer plane.

The “induced anchoring direction” means the alignment direction of LCs or RMs induced by modification of the film or layer surface. In this application the process used of surface modification is a plasma beam irradiation or rubbing process.

In optics, the axis of anisotropy (equal to alignment axis for LC materials) is the optical axis. The light polarized in the direction of optical axis has the lowest or the highest speed in anisotropic material. In this sense the optical axis is frequently called a “slow axis” or a “fast axis”. The optical axis is the slow axis in the films of uniaxially ordered calamitic molecules and, correspondingly, the fast axis in the films of uniaxially ordered discotics.

The term “A plate/film” means an optical retarder utilizing a layer of uniaxially birefringent material with its extraordinary axis oriented parallel to the plane of the layer.

The term “C plate/film” means an optical retarder utilizing a layer of uniaxially birefringent material with its extraordinary axis oriented perpendicular to the plane of the layer.

The term “O plate/film” means an optical retarder utilizing a layer of uniaxially birefringent material with its extraordinary axis tilted at an angle to the plane of the layer.

In A- and C-plates comprising optically uniaxial birefringent liquid crystal material with uniform orientation, the optical axis of the film is given by the direction of the extraordinary axis.

An A plate or C plate comprising optically uniaxial birefringent material with positive birefringence is also referred to as “+A/C plate” or “positive A/C plate”. An A plate or C plate comprising a film of optically uniaxial birefringent material with negative birefringence is also referred to as “−A/C plate” or “negative A/C plate”.

In case of doubt the definitions as given in C. Tschierske, G. Pelzl and S. Diele, Angew. Chem. 2004, 116, 6340-6368 shall apply.

### BRIEF DESCRIPTION OF THE DRAWINGS

FIG. 1 schematically illustrates the processes of a) surface etching, b) sputtering deposition and c) direct deposition using a particle beam.

FIG. 2 schematically illustrates the construction of an anode layer source as used in a process according to the present invention.

FIGS. 3a and 3b schematically illustrate the plasma beam irradiation schemes in a process according to the present invention, wherein (a) and (b) correspond to source and sample moving arrangements, respectively.

FIGS. 4a and 4b illustrate the exposure geometries and the in-plane projections of the alignment directions of the first and second LC layers of an LC/LC multilayer prepared by a process according to the present invention (directions A₁ and A₂, respectively).

FIG. 5 shows the measured (dots) and modeled (solid line) analyzer angle φ versus sample rotation angle φ curves for the first RM sub-film of Example 1.

FIG. 6 shows a photograph, and its schematical illustration, of the two-layer RM film of Example 1 between two polarizers, and its schematically illustration.

FIG. 7 shows a photograph, and its schematical illustration, of the first RM sub-layer (1) and the two-layer RM film (2) of Example 3 between two crossed polarizers, wherein in case (a) the optic axis of the first RM sub-layer is parallel to one of the polarizers, and in case (b) the optic axis of the first RM sub-layer forms an angle of 45° with the polarizers.

FIG. 8 shows the measured (dots) and modeled (solid line) analyzer angle φ versus sample rotation angle φ curves for the two-layer RM film of Example 3.

FIG. 9 shows the measured (dots) and modeled (solid line) analyzer angle φ versus sample rotation angle φ curves for the two-layer RM film of Example 4.

FIG. 10 shows a photograph, and its schematical illustration, of the two-layer RM film of Comparative Example 1 between two crossed polarizers (a) and through one polarizer (b, c).

FIG. 11 shows a photograph, and its schematical illustration, of the two-layer RM film of Example 5 between two crossed polarizers (a) and through one polarizer (b, c).

### DETAILED DESCRIPTION OF THE INVENTION

The present invention discloses how two A-films (or O-films) can be coated directly on top of each other with their optical axis (or projections of these axis on the film's plane) not parallel to each other, and to show that such a technology can be used as a cost effective method of preparing a multilayer retarder like for example an AQWF.

For example, the process of the present invention enables to control alignment in the upper film and thereby the direction of the optical axis in this film. In this way, for example a stack of two or more A and/or O films can be prepared on one substrate, avoiding the need for a lamination step.

The invention further relates to multilayer of anisotropic layers directly deposited one on another without any interlayers and avoiding any lamination steps.

The first layer (or layers) in the multilayer of the present invention is a layer of anisotropic material, like for example a crystal plate, an aligned and solidified LC film, such as a dried (in case of lyotropic LCs), polymerized (in case of RMs) or vitrified (in case of thermotropic LCs) LC film, a stretched, sheared or photoaligned polymeric layer, or a layer of an LC polymer.

The second layer (or layers) in the multilayer is a layer of one or more LCs, like for example non-reactive LCs, RMs, or LC polymer(s). The second layer made of LC material is coated directly on top of the first layer. Before deposition of the second layer, the first layer is treated using a particle beam etching technique as described for example in WO 2008/028553 A1, the entire disclosure of which is incorporated into this application by way of reference. This procedure provides an anchoring direction for the LCs forming the second layer, which are adjacent to the first layer. After deposition the second layer is optionally polymerised.

Third, fourth or further layers, for example A and/or O films, can then be coated on top of the prepared stack using the same aligning procedure as applied for the second layer. In addition to “layer by layer” formation of stack, a “layer between layers” principle can be used when a second layer is formed between two first layers, or between first and third layers, at least one of which is preliminarily subjected to particle beam etching.

The process according to the present invention shows that the anchoring of LCs in the second layer imparted by the plasma beam process overcomes the anchoring of LCs in the second layer caused by the anisotropy of the first type layer, i.e. if the first layer has an intrinsic anchoring direction, the particle beam action overcomes this anchoring force. This is surprising and could not be expected from the prior art documents.

Preferably, the first layer is the layer of LC, which can be solidified, for example dried, polymerised or vitrified. Very preferably, the first layer is a layer of one or more RMs. Such a layer can be aligned by any suitable method, including but not limited to conventional rubbed polyimide alignment, photoalignment, ion or plasma beam aided alignment or by any kind of deposition alignment technique.

Using the coatings enumerated above, uniform planar and tilted alignment of LCs films is achieved, wherein demonstrating the optical retardation of positive A and positive O plates. Alignment patterning of these films is also possible.

Thus the disclosed multilayer contains sub-layers whose alignment direction is not determined by the intrinsic anchoring directions of neighbouring sub-layers. This means that the angle between induced anchoring direction and intrinsic anchoring direction is not equal to zero.

Consequently, in case of two calamitic LC layers or two discotic LC layers the alignment direction (equal to optical axis) of the first layer or its projection on the said first layer and the anchoring direction of this layer or its projection on the said first layer form an angle with each other that is different from 0°. In case the first layer is a calamitic (discotic) layer and the second layer is a discotic (calamitic) layer, the optical axis of the first layer or its projection on the said first layer and the alignment direction of the second layer or its projection on the said first layer form an angle with each other that is different from 90°.

Especially preferred is a process, wherein the multilayer consists of at least one first layer of polymerised liquid crystal (LC) material of calamitic type and at least one second layer of LC material of calamitic type, which is optionally polymerised, and the process comprises the following steps

A) providing a first layer of polymerised calamitic LC material having an optical axis,
B) exposing the surface of said first layer to a beam of moderately accelerated particles, thereby providing surface etching and inducing an anchoring direction on said surface of said first layer,
C) providing a second layer of calamitic LC material onto said exposed surface of said first layer,
D) optionally polymerising said second layer of LC material,
wherein the projection of the optical axis (alignment axis) of said first layer into the plane of the first layer and the projection of the induced anchoring direction on said surface of said first layer into the plane of this layer produced by the particle beam exposure form an angle that is different from 0°.

Further preferred is a process wherein the multilayer consists of at least one first layer of polymerised liquid crystal (LC) material of discotic type and at least one second layer of LC material of discotic type.

Further preferred is a process wherein the multilayer consists of at least one first layer of polymerised liquid crystal (LC) material of calamitic type and at least one second layer of LC material of discotic type.

Further preferred is a process wherein the multilayer consists of at least one first layer of polymerised liquid crystal (LC) material of discotic type and at least one second layer of LC material of calamitic type.

Particle beam alignment methods are known in prior art and have been reported to show promising results also for industrial applications. As particles for example ions, neutral atoms, electrons, or mixtures thereof, in particular a plasma, can be used. Principally the following particle beam processes can be selected for LC alignment:

1) Surface etching,
2) Sputtering deposition,
3) Direct deposition.

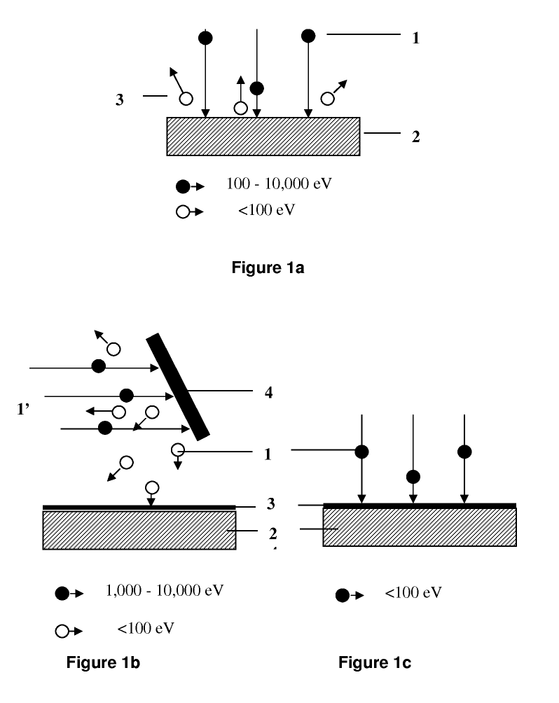

The different processes mentioned above may occur simultaneously, but their efficiency depends on the energy of the particles. These three processes are discussed below and schematically presented in FIG. 1.

In case of process 1) as shown in FIG. 1a, if the beam of accelerated (1) particles has an energy of 100 eV-10,000 eV, the so-called surface etching/milling process is preferred. In this case particles (1) bombarding the substrate (2) extract the substrate's atoms (3) and do thereby cause material ablation. This may be accompanied by breaking chemical bonds and, in case of reactive gases, by plasma chemical reactions. This so-called surface etching process can be used for surface cleaning but also for alignment.

In case of process 2) as shown in FIG. 1b, if an accelerated beam of particles (1′) having an energy of 100 eV-10,000 eV is directed to any other substrate (4) (target), it causes material ablation from the target (4). The extracted particles (1) have a lower energy (<100 eV) and can be deposited on the desirable substrate (2) forming a film (3) thereon. This process is known as particle beam sputtering deposition.

Finally, in case of process 3) as shown in FIG. 1c, if a beam of particles (1) having very low energy (far less than 100 eV) is directed on the substrate (2), the particles have not enough energy to extract substrate's atoms. Instead, they may condense and react on the substrate forming a permanent film (3) thereon. This process is also known as direct (particle beam) deposition.

This classification includes only methods dealing with particle beams formed by ion and plasma beam sources. It does not include thermally initiated particle beams and associated methods like physical and chemical vapour deposition, which are much less convenient for LC technology, especially in case of coating large-area substrates.

For the purpose of the present invention the surface etching technique as described above in process 1) and as illustrated in FIG. 1a is used.

To ensure uniform alignment of the LC molecules, the particle beam is usually directed obliquely to the alignment substrate. In this case, the surface of the modified film becomes anisotropic and thereby capable to align LCs. The induced surface anisotropy reveals itself in an anisotropy of relief and an anisotropy of molecular or intermolecular bonds.

The surface etching process 1) is disclosed for example in U.S. Pat. No. 4,153,529; P. Chaudhari, J. Lacey, S. A. Lien, and J. Speidell, Jpn J Appl Phys 37(1-2), L55-L56 (1998); P. Chaudhari et al, Nature 411, 56-59 (2001). In contrast to first attempts of etching alignment, in which particles of rather high energy (several keV) are used, in later experiments the energy is reduced to 0.1 keV. This allowed to treat only the very top layer of the alignment film so that surface deterioration is minimized. This technique provides low-pretilt alignment of good uniformity on the huge variety of organic and inorganic substrates.

By using plasma beam sources of linear construction, the etching technique is applied for the alignment treatment of large-area substrates used in modern LCD technology, as disclosed for example in WO2004/104682 A1. The etching process has also been proposed for the alignment of RMs and polymerised RMs, as disclosed for example in WO 2008/028553 A1 and O. Yaroshchuk, R. Kravchuk, O. Parri et al., Journal of the SID 16/9, 905-909 (2008).

The particle beam etching technique according to the present invention has a number of advantages compared to alignment methods of prior art:
Compared to rubbing, it provides better microscopic uniformity of planar and homeotropic alignment, and overcomes other shortcomings of rubbing as mentioned above.
Compared to sputtering deposition, it is a technologically more simple process. Thus, for example a target is not needed. A low voltage operation diminishes the amount of parasitic discharges “dusting” the working area due to particle generation.

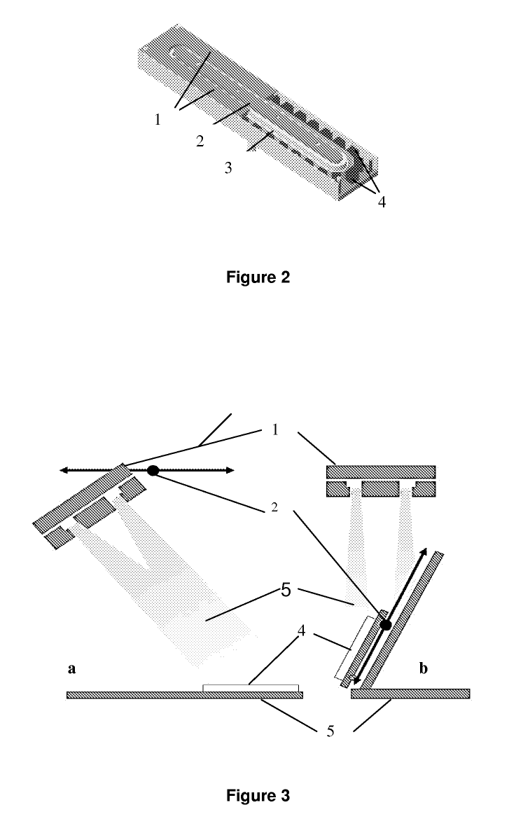

The plasma beam is preferably provided by an anode layer source (ALS) from the Hall family of electrostatic sources. This is designed to provide a collimated flux of particles from practically any gaseous feed. The particle flux is formed in the crossed electric and magnetic fields directly within the discharge channel. Because of the high anode potential, the part of plasma is pushed out of the discharge area so that a beam of accelerated plasma is generated. In contrast to the Kaufman source widely used for the ion beam alignment processing, ALS does not contain grids and hot elements (such as filaments and other secondary electron sources); the structure is thus simple and allows one to substantially increase reliability. The ALS construction is exemplarily depicted in FIG. 2, including outer cathodes (1), inner cathodes (2), anode (3) and permanent magnets (4). The important feature of the ALS is a racetrack shape of glow discharge so that the source generates two “sheets” of accelerated plasma. This allows one to treat relatively large substrates by translation or roll-to-roll translation for flexible plastic films. In the present invention, preferably two exposure geometries giving similar alignment results are used. The irradiation schemes preferably used are exemplarily illustrated in FIG. 3, where (1) indicates the ALS, (2) the moving direction, (3) the plasma sheet, (4) the substrate and (5) the substrate holder. Therein, scheme a) shows geometry 1 with the source moving and scheme b) shows geometry 2 with the substrate holder moving. The exposure angle, accounted from the substrate's normal, is preferably in the range from 45° to 85°. The distance between source and substrate depends on the exposure angle. For example, in exposure geometry b) of FIG. 3, it is typically varied from 6 to 25 cm. With lengthening this distance the pressure or anode potential should preferably be increased to keep constant the current density of plasma flux.

The residual pressure in a chamber should preferably be lower than 3*10⁻⁵ Torr. The feed gas typically used is argon. The working pressure, p, is preferably in the range from 1-6*10⁻⁴ Torr. The anode potential, U, varies typically from 400 V to 3000 V. Typically current density, j, is preferably in the range 0.5-50 μA/cm² determined by the values of p and U.

It is understood that in the process as described above and below, usually only the surface of the alignment imparting layer (e.g. the first layer) that is adjacent to the layer to be aligned (e.g. the second layer) is subjected to the particle beam etching treatment.

As explained above, the particle beam etching process will cause material ablation from the exposed surface of the first RM layer. At the oblique incidence of particle beam the roughness of first RM layer becomes anisotropic, as in the case of other materials [see O. Yaroshchuk et al., Liq. Cryst. 31, 6, 859-869 (2004)]. Besides, oblique irradiation may cause angularly selective breaking of some molecular bonds on the film's surface [see J. Stoehr et al., Science, P. Chaudhari et al., Nature, 411, 56 (2001)]. Both these mechanisms contribute to surface anisotropy and LC alignment.

A typical and preferred process of preparing a two-layer or multilayer film of calamitic LCs according to the present invention comprises the following steps:

A1) A first layer is prepared by coating an appropriate calamitic type RM or calamitic type RM solution onto an alignment treated substrate.
A2) If a solution is used, the solvent is evaporated. Then the first RM layer is polymerised, for example by exposure to heat or actinic radiation, to give a well aligned film, preferably a +A plate or +O plate.
B) The surface of the first RM layer is then obliquely exposed to a plasma beam, thereby inducing an anchoring direction, wherein said anchoring direction or its projection into the layer plane is selected to form the desired angle (different from 0°) with the optic axis of the first layer or its projection into the layer plane.
C) A second layer of an LC or RM, or a mixture or solution thereof, is coated onto the above treated first RM layer. If a solvent is present it is evaporated. Due to the etching process the first RM layer will induce alignment of the LCs or RMs of the second layer in the induced anchoring direction, which is different from the optical axis and the intrinsic anchoring direction of the first layer.
D) The second RM layer is optionally polymerised as described above to give a well aligned film, preferably a +A plate or +O plate.

The alignment treated substrate for preparing the first RM layer (step A1) is for example a glass or plastic substrate, which is optionally coated with an alignment layer, for example a layer of rubbed polyimide or obliquely deposited SiOₓ, or which has been subjected to an etching process by particle (ion or plasma) beam treatment as described above and below.

In case the first layer is prepared on a substrate that is subjected to particle beam etching treatment, the preferred embodiments as described above and below for the process of etching the surface of the first layer can also be directly applied to the process of etching the substrate (i.e. the term “first layer” in these preferred embodiments can be replaced by “substrate”).

The process according to the present invention is suitable to provide uniform alignment of for example thermotropic nematic, cholesteric or smectic LC or RM compounds or mixtures, lyotropic LCs and RMs including chromonic LCs. The LCs or RMs are applied, preferably as a thin layer onto the respective substrate.

It is also possible to prepare a second layer as described above and below between two first layers as described above and below, wherein one or both of said first layers were subjected to a particle beam etching treatment process according to the present invention.

Alternatively it is possible to prepare a second layer as described above and below between a first layer as described above and below and a third layer, preferably selected from polymerised RM layers, wherein one or both of said first and said third layer were subjected to a particle beam etching treatment process according to the present invention.

If the second layer is placed between two layers, only one of which was subjected to etching treatment, the anchoring direction imparted onto the second layer by the treated layer can be different from the intrinsic anchoring direction imparted onto the second layer by the untreated layer. In this case the alignment direction can vary throughout the second layer from one direction at one surface to a different direction at the opposite surface. This allows for the preparation of a second layer with hybrid alignment, for a layer with planar and twisted alignment.

Alternatively such a layer with hybrid alignment can also be achieved for example by preparing it between two layers subjected to etching treatment (e.g. between two of the first layers or between a first and a third layer as described above), wherein the anchoring directions resulting from etching treatment of the two treated layers are different from each other.

In addition, the preparation of a multilayer film on rollable plastic substrates can be realized by roll-to-roll translation. In this case the plasma beam processing is provided during roll-to-roll rewinding of the first layer. For example, this can be achieved by placing the roll in a vacuum chamber so that the appropriate vacuum is realised, and subsequently exposing the layer to plasma etching whilst moving it from the unwind roller to the wind-up roller. This roll can then be subsequently coated with an appropriate LC or RM solution for the second layer using conventional coating techniques, and the RMs can subsequently be polymerised in situ for example by exposure to UV light. In this way an oriented, polymerised RM multilayer film can be prepared, and can then also be laminated to other films, for example polarizers, by roll-to-roll lamination, in one continuous process.

In addition, patterned alignment (i.e. a pattern of regions with different alignment) of the surface of the first layer can be realized by the use of masks and multiple etching steps. Without realignment of the particle beam source and the substrate the ALS irradiation system allows one mask and two-step irradiation process to obtain patterns with mutually perpendicular optical axis in the film plane.

By using the method according to the present invention, various alignment directions can be induced in the LCs or RMs, for example planar, tilted or splayed alignment, depending on the content of the deposited film, incidence angle of the plasma flux, plasma intensity and fluence, and the type of LCs or RMs used. Thus, it is possible to prepare LC layers or polymerised RM films having the optical properties of an A plate or an O plate. A further detailed description how alignment can be controlled can be found in the examples, however, it should not be considered as being limited to these examples, but instead as a general description that can also be applied to other embodiments of this invention.

As substrate for preparing the first layer for example glass or quartz sheets or plastic films can be used. Isotropic or birefringent substrates can be used. In case the substrate is not removed from the polymerised film after polymerisation, preferably isotropic substrates are used. Suitable and preferred plastic substrates are for example films of polyester such as polyethyleneterephthalate (PET) or polyethylene-naphthalate (PEN), polyether sulfone (PES), polyvinylalcohol (PVA), polycarbonate (PC) or triacetylcellulose (TAC), very preferably PET or TAC films. The substrate can also be a component of an optical, electrooptical or electronic device like an LC display, for example glass substrates containing ITO electrodes, passive or active matrix structures, silicon wafers with electronic structures used for example in LCoS devices, or colour filter layers. Substrates comprising one or more layers or films of the above-mentioned materials can also be used.

When preparing polymer films, it is also possible to put a second substrate on top of the coated RMs prior to and/or during and/or after polymerisation. The substrates can be removed after polymerisation or not. When using two substrates in case of curing by actinic radiation, at least one substrate has to be transmissive for the actinic radiation used for the polymerisation.

The LC or RM material can be applied onto the substrate carrying the alignment film by conventional coating techniques like spin-coating or blade coating. It can also be applied to the substrate by conventional printing techniques which are known to the expert and described in the literature, like for example screen printing, offset printing, reel-to-reel printing, letter press printing, gravure printing, rotogravure printing, flexographic printing, intaglio printing, pad printing, heat-seal printing, ink-jet printing or printing by means of a stamp or printing plate.

It is also possible to dissolve the LC or RM material in a suitable solvent. This solution is then coated or printed onto the substrate carrying the alignment film, for example by spin-coating or printing or other known techniques, and the solvent is evaporated off before polymerisation. In many cases it is suitable to heat the mixture in order to facilitate the evaporation of the solvent. As solvents for example standard organic solvents can be used. The solvents can be selected for example from ketones such as acetone, methyl ethyl ketone, methyl propyl ketone or cyclohexanone; acetates such as methyl, ethyl or butyl acetate or methyl acetoacetate; alcohols such as methanol, ethanol or isopropyl alcohol; aromatic solvents such as toluene or xylene; halogenated hydrocarbons such as di- or trichloromethane; glycols or their esters such as PGMEA (propyl glycol monomethyl ether acetate), γ-butyrolactone, and the like. It is also possible to use binary, ternary or higher mixtures of the above solvents.

The method according to the present invention is also compatible with other vacuum processes employed in LCD industry, including but not limited to, ITO deposition, TFT coating, vacuum filling of LCDs for example by the one drop filling (ODF) method, etc. This can be advantageously used in an entirely vacuum technological line of LCD production, which can strongly reduce the well-known problems related to dust, humidity, air ions etc.

Especially preferred are the following embodiments of the invention (therein the term “particle beam” includes a plasma beam or ion beam):
the first layer is prepared on a substrate that is subjected to a particle beam etching process as described above and below to induce desired alignment of RMs in the first layer,
the substrate for preparing the first layer does not comprise an alignment layer and/or is not rubbed,
the substrate for preparing the first layer comprises a rubbed alignment layer, for example rubbed polyimide,
the substrate for preparing the first layer comprises an organic or inorganic material, preferably selected from glass, quartz, plastic or silicon, or is a colour filter,
at least a portion of, preferably the whole, first layer is exposed to a particle beam from a particle beam source (etching step), wherein the particle beam is directed at the first layer such that the symmetry axis of the source (particle beam direction) forms an angle to the plane of the first layer (“incidence angle”),
the incidence angle is from 5° to 70°, preferably from 5° to 45°, the first layer is positioned at a distance of from 5 to 100 cm, preferably from 6 to 20 cm from the particle beam source,
the exposed portion of the first layer imparts an anchoring direction (to the LCs or RMs of the second layer) having an azimuth angle φ_{LC} (the angle between in-plane projection of the plasma beam and in-plane projection of the axis of LC alignment) of about 0° and a zenital angle or pretilt angle φ_{LC} (the angle between the plane of LC layer and the axis of LC alignment) of 0° to 90°, or an azimuth angle φ_{LC} of about 90° and a zenital angle θ of about 0°,
the particle beam source is a closed drift thruster,
the particle beam source is an anode layer thruster,
the current density of the particle beam is preferably from 0.1 to 1000 μA/cm², very preferably from 0.5 to 50 μA/cm²,
the ion energy of the particle beam is from 100 to 5000 eV, preferably from 400 eV to 2000 eV,
the particle beam is generated from a gas or a mixture of two or more gases, preferably selected from the group consisting of rare gases, such as Ar, Kr, Xe, etc.,
the exposure time is from 0.5 to 5 min,
the process further comprises the step of utilizing a mask to prevent the particle beam from reaching a predetermined portion of the first layer, for example by applying a mask to the substrate before or during particle beam exposure,
the alignment induced in the first layer comprises a pattern of at least two regions having different alignment direction,
the particle beam is in the form of a sheet,
the process comprises the step of moving the first layer through a path of the particle beam,
the first layer is exposed to the particle beam on a continuously moving substrate, preferably a flexible plastic substrate, that is provided or unwound from a roll in a continuous or roll-to-roll process,
the RMs used to produce the first and the second layer preferably are of the same type, i.e. either calamitic or discotic, very preferably of calamitic type.
the RMs used to produce the first and the second layers have a nematic mesophase (liquid crystal phase), preferably only a nematic mesophase.
the alignment induced in the first RM layer is planar alignment,
the alignment induced in the first RM layer is tilted or splayed alignment,
the alignment induced in the second LC or RM layer is planar alignment,
the alignment induced in the second LC or RM layer is tilted or splayed alignment,
the thickness of the LC or RM layer, or in case of a multilayer the thickness of one or more of, preferably each of the single layers, is from 500 nm to 10 μm, preferably from 1 to 5 μm,
the multilayer comprises, preferably consists of, a first polymerised RM layer and a second layer that is an unpolymerised LC layer,
the multilayer comprises, preferably consists of, a first polymerised RM layer and a second polymerised RM layer,
the multilayer comprises, preferably consists of, two layers with planar alignment (A plate),
the multilayer comprises, preferably consists of, two layers with tilted or splayed alignment (O plate),
the multilayer comprises, preferably consists of, a planar layer (A plate) and a tilted or splayed layer (O plate),
the multilayer comprises, preferably consists of, two polymerised RM layers, wherein the orientation directions of the RMs in both RM layers, or their projection onto the film plane, form an angle from 30° to 90°, preferably from 60° to 90°, most preferably 60° or 90°, relative to each other,
the multilayer comprises, preferably consists of, two A plates, wherein the slow axes form an angle from 30° to 90°, preferably from 60° to 90°, most preferably 60° or 90°, relative to each other,
the multilayer comprises, preferably consists of, two O plates, wherein the projections of the slow axes into the film plane form an angle from 30° to 90°, preferably from 60° to 90°, most preferably 60° or 90°, relative to each other,
the multilayer comprises, preferably consists of, one A plate and one O plate, wherein the slow axis of the A plate and the projection of the slow axis of the O plate onto the film plane form an angle from 30° to 90°, preferably from 60° to 90°, most preferably 60° or 90°, relative to each other.

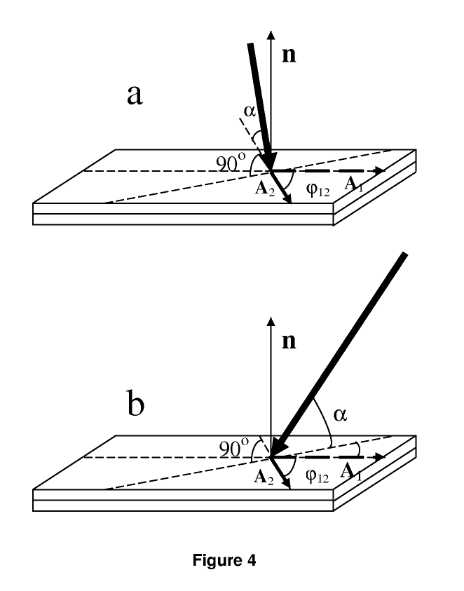

The preferred schemes of irradiation of the first RM layer are schematically depicted in FIGS. 4a and 4b, where (1) is a substrate, (2) is the first RM layer, (3) is the plasma beam, A1 is the intrinsic in-plane anchoring direction of the first RM layer, A2 is the plasma beam induced in-plane anchoring direction of LC or RM on the first layer, φ₁₂ is the angle between A1 and A2, and α is the incidence angle of plasma beam. Case (a) corresponds to low exposure dose when the induced anchoring direction A2 lies in the incidence plane of plasma beam (alignment mode 1). In turn, case (b) corresponds to higher dose, when the induced anchoring direction A2 is perpendicular to the plane of plasma beam incidence (alignment mode 2).

The method according to the present invention is not limited to specific LC or RM materials, but can in principle be used for alignment of all LCs or RMs known from prior art. The LCs and RMs are preferably selected from calamitic or discotic compounds demonstrating thermotropic or lyotropic liquid crystallinity, very preferably calamitic compounds, or mixtures of one or more types of these compounds having LC mesophases in a certain temperature range. These materials typically have good optical properties, like reduced chromaticity, and can be easily and quickly aligned into the desired orientation, which is especially important for the industrial production of polymer films at large scale. The LCs and RMs may contain dichroic dyes or further components or additives. The LCs can be small molecules (i.e. monomeric compounds) or LC oligomers or LC polymers.

Especially preferred are LCs or RMs, or mixtures comprising one or more LC or RM compounds, which have thermotropic nematic, smectic or cholesteric mesophases.

Preferably the LC material is a mixture of two or more, for example 2 to 25 LC compounds. The LC compounds are typically low molecular weight LC compounds selected from nematic or nematogenic substances, for example from the known classes of the azoxybenzenes, benzylidene-anilines, biphenyls, terphenyls, phenyl or cyclohexyl benzoates, phenyl or cyclohexyl esters of cyclohehexanecarboxylic acid, phenyl or cyclohexyl esters of cyclohexylbenzoic acid, phenyl or cyclohexyl esters of cyclohexylcyclohexanecarboxylic acid, cyclohexylphenyl esters of benzoic acid, of cyclohexanecarboxylic acid and of cyclo-hexylcyclohexanecarboxylic acid, phenylcyclohexanes, cyclohexyl-biphenyls, phenylcyclohexylcyclohexanes, cyclohexylcyclohexanes, cyclohexylcyclohexenes, cyclohexylcyclohexylcyclohexenes, 1,4-bis-cyclohexylbenzenes, 4,4′-bis-cyclohexylbiphenyls, phenyl- or cyclo-hexylpyrimidines, phenyl- or cyclohexylpyridines, phenyl- or cyclo-hexylpyridazines, phenyl- or cyclohexyldioxanes, phenyl- or cyclo-hexyl-1,3-dithianes, 1,2-diphenyl-ethanes, 1,2-dicyclohexylethanes, 1-phenyl-2-cyclohexylethanes, 1-cyclohexyl-2-(4-phenylcyclohexyl)-ethanes, 1-cyclohexyl-2-biphenyl-ethanes, 1-phenyl2-cyclohexyl-phenylethanes, optionally halogenated stilbenes, benzyl phenyl ether, tolanes, substituted cinnamic acids and further classes of nematic or nematogenic substances. The 1,4-phenylene groups in these compounds may also be laterally mono- or difluorinated. The LC mixture is preferably based on achiral compounds of this type.

The most important compounds that can be used as components of the LC mixture can be characterized by the following formula

R′-L′-G′-E-R″

wherein L′ and E, which may be identical or different, are in each case, independently from one another, a bivalent radical from the group formed by -Phe-, -Cyc-, -Phe-Phe-, -Phe-Phe-Phe-, -Phe-Cyc-, -Cyc-Cyc-, -Pyr-, -Dio-, -Pan-, -B-Phe-, -B-Phe-Phe- and -B-Cyc- and their mirror images, where Phe is unsubstituted or fluorine-substituted 1,4-phenylene, Cyc is trans-1,4-cyclohexylene or 1,4-cyclohexenylene, Pyr is pyrimidine-2,5-diyl or pyridine-2,5-diyl, Dio is 1,3-dioxane-2,5-diyl, Pan is pyrane-2,5-diyl and B is 2-(trans-1,4-cyclohexyl)ethyl, pyrimidine-2,5-diyl, pyridine-2,5-diyl, 1,3-dioxane-2,5-diyl, or pyrane-2,5-diyl.

G′ in these compounds is selected from the following bivalent groups or their mirror images:

—CH═CH—, —CH═CY—, —CY═CY—, —C≡C—, —CH₂—CH₂—, —CF₂O—, —CH₂—O—, —CH₂—S—, —CO—O—, —CO—S— or a single bond, with Y being halogen, preferably F, or —CN.

R′ and R″ are, in each case, independently of one another, alkyl, alkenyl, alkoxy, alkenyloxy, alkanoyloxy, alkoxycarbonyl or alkoxycarbonyloxy with 1 to 18, preferably 3 to 12 C atoms, or alternatively one of R′ and R″ is F, CF₃, OCF₃, Cl, NCS or CN.

In most of these compounds R′ and R″ are, in each case, independently of each another, alkyl, alkenyl or alkoxy with different chain length, wherein the sum of C atoms in nematic media generally is between 2 and 9, preferably between 2 and 7.

Many of these compounds or mixtures thereof are commercially available. All of these compounds are either known or can be prepared by methods which are known per se, as described in the literature (for example in the standard works such as Houben-Weyl, Methoden der Organischen Chemie [Methods of Organic Chemistry], Georg-Thieme-Verlag, Stuttgart), to be precise under reaction conditions which are known and suitable for said reactions. Use may also be made here of variants which are known per se, but are not mentioned here.

Suitable RMs are known to the skilled person and are disclosed for example in WO 93/22397, EP 0 261 712, DE 195 04 224, WO 95/22586, WO 97/00600, U.S. Pat. No. 5,518,652, U.S. Pat. No. 5,750,051, U.S. Pat. No. 5,770,107 and U.S. Pat. No. 6,514,578. Examples of suitable and preferred monoreactive, direactive and chiral RMs are shown in the following list.

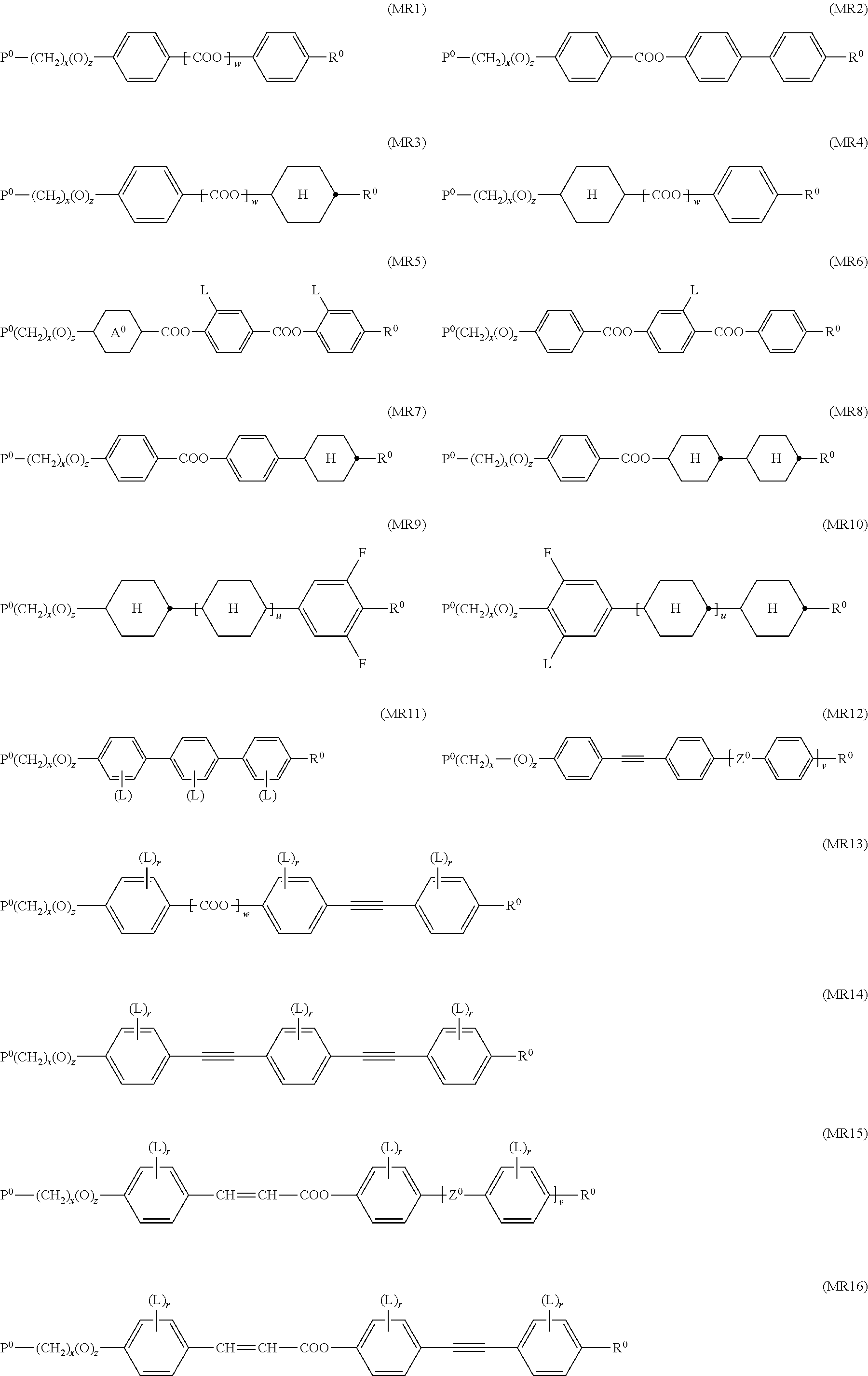

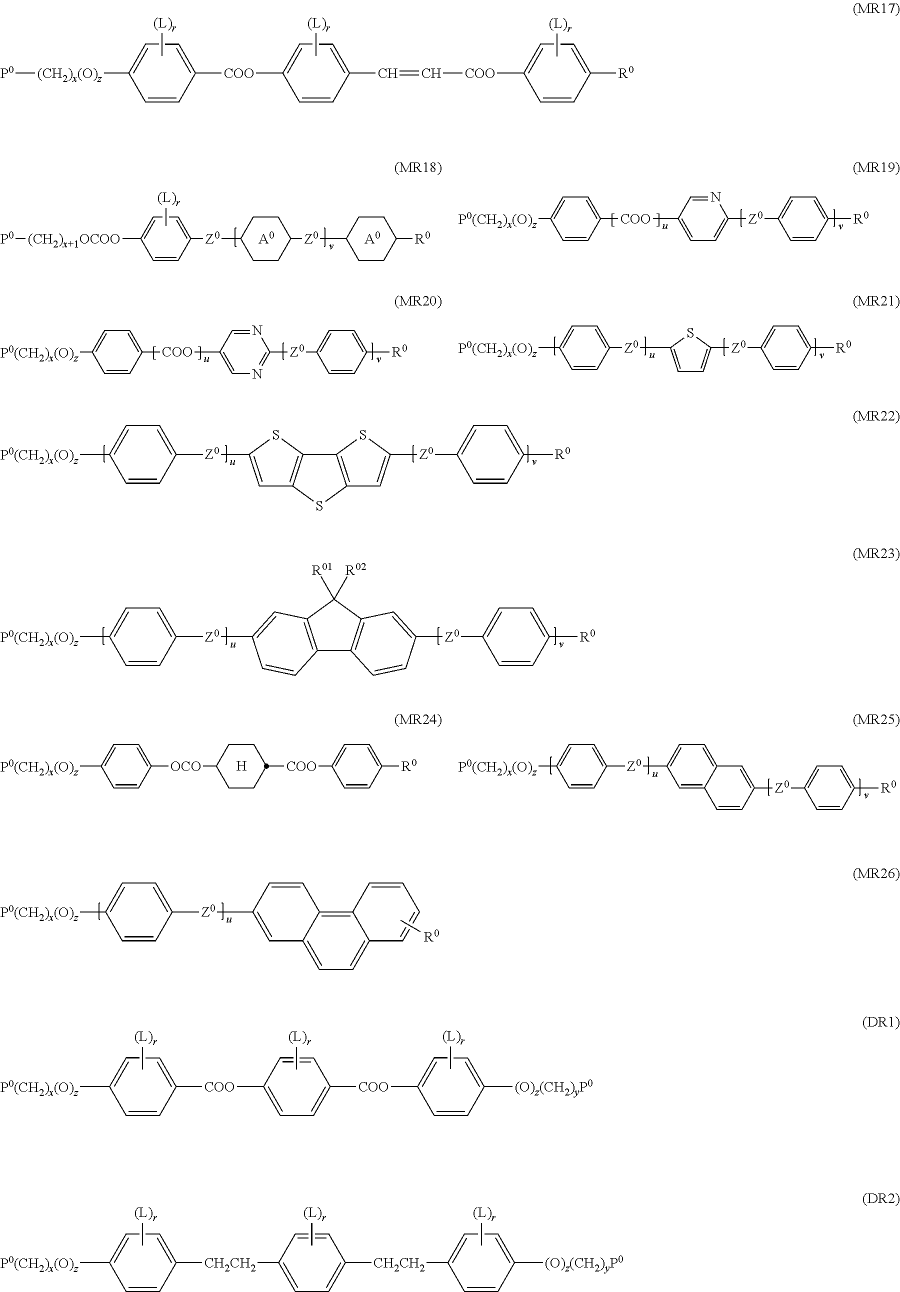

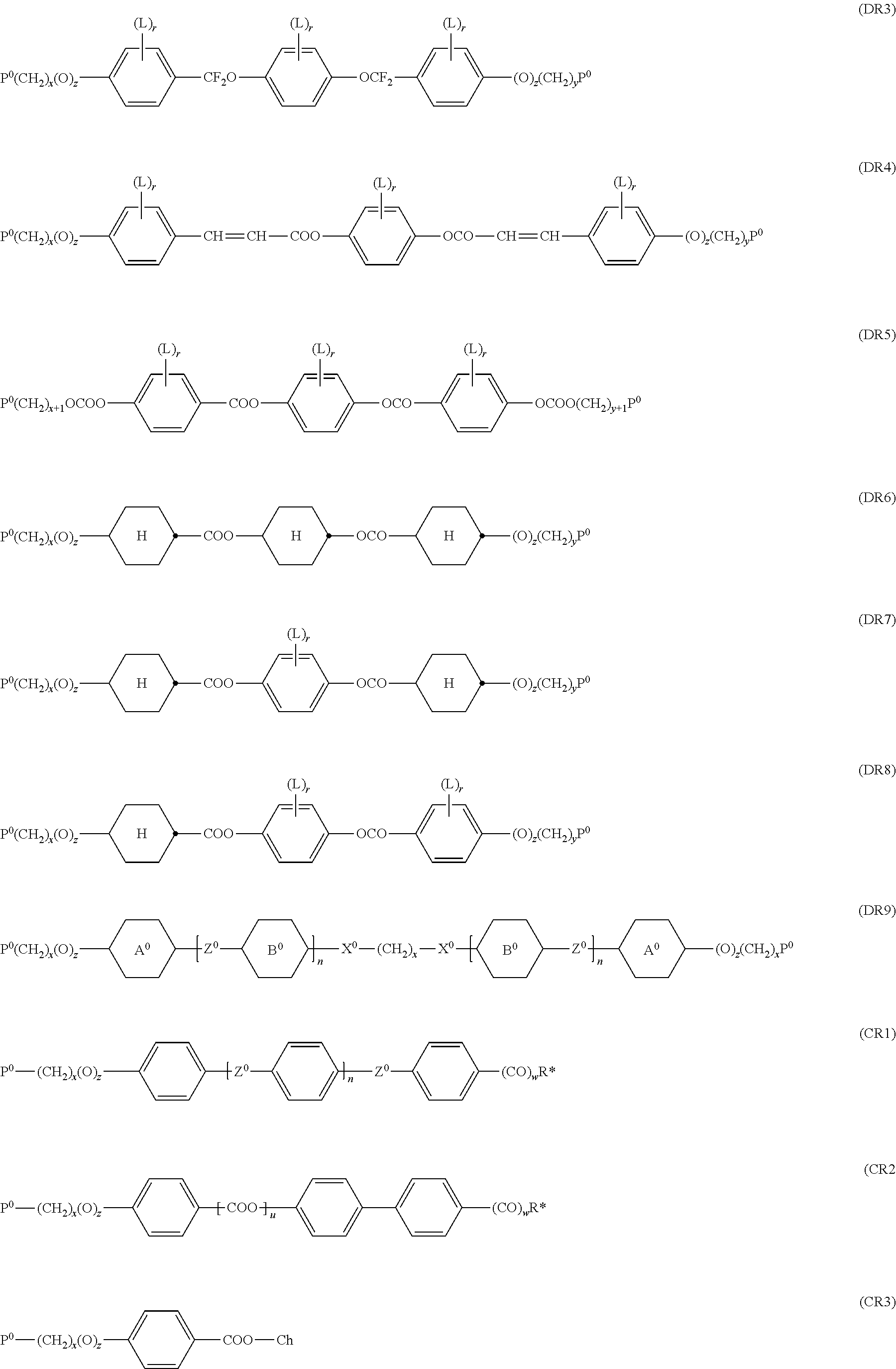

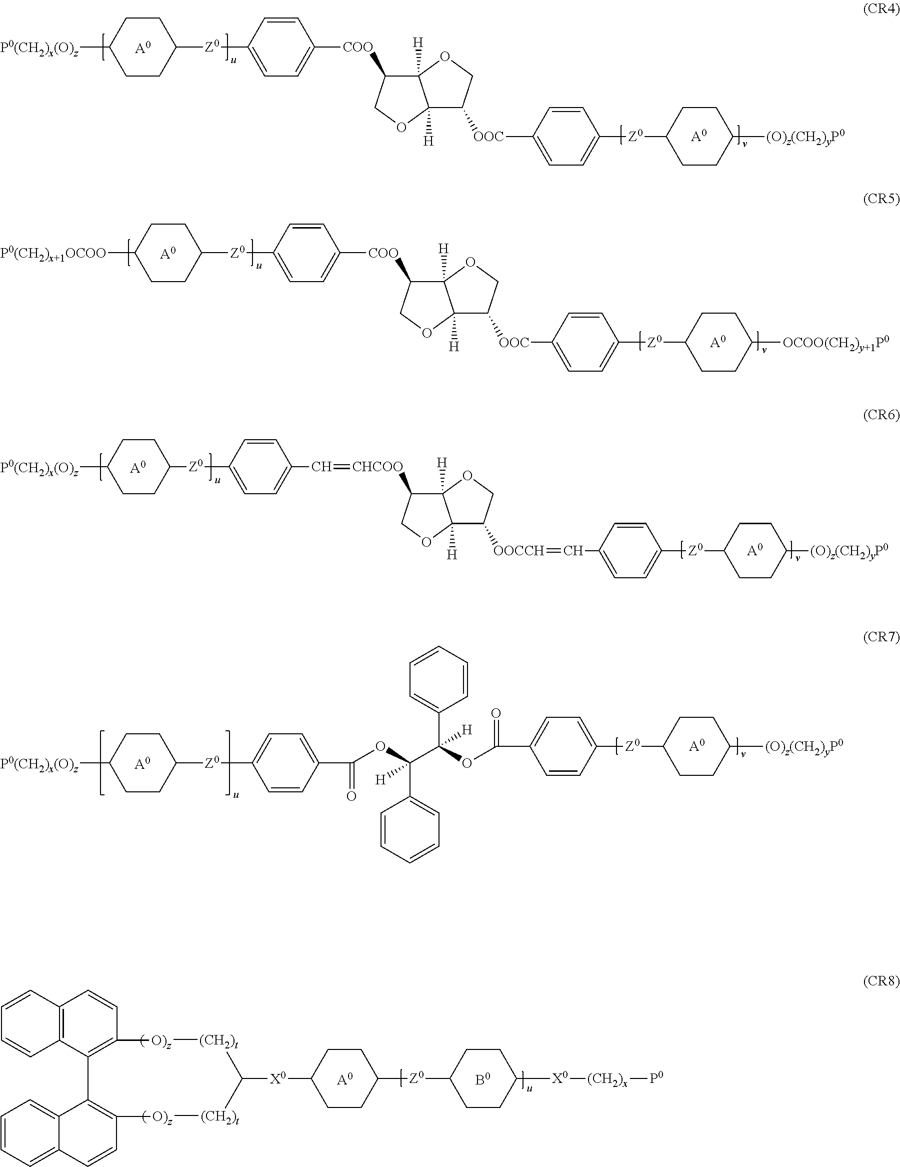

wherein
P⁰ is, in case of multiple occurrence independently of one another, a polymerisable group, preferably an acryl, methacryl, oxetane, epoxy, vinyl, vinyloxy, propenyl ether or styrene group,
A⁰ and B⁰ are, in case of multiple occurrence independently of one another, 1,4-phenylene that is optionally substituted with 1, 2, 3 or 4 groups L, or trans-1,4-cyclohexylene,
Z⁰ is, in case of multiple occurrence independently of one another, —COO—, —OCO—, —CH₂CH₂—, —C≡C—, —CH═CH—, —CH═CH—COO—, —OCO—CH═CH— or a single bond,
R⁰ is alkyl, alkoxy, thioalkyl, alkylcarbonyl, alkoxycarbonyl, alkylcarbonyloxy or alkoxycarbonyloxy with 1 or more, preferably 1 to 15 C atoms which is optionally fluorinated, or is Y⁰ or P—(CH₂)_{y}—(O)_{z}—,
Y⁰ is F, Cl, CN, NO₂, OCH₃, OCN, SCN, SF₅, optionally fluorinated alkylcarbonyl, alkoxycarbonyl, alkylcarbonyloxy or alkoxycarbonyloxy with 1 to 4 C atoms, or mono- oligo- or polyfluorinated alkyl or alkoxy with 1 to 4 C atoms,
R^{01,02} are independently of each other H, R⁰ or Y⁰,
R* is a chiral alkyl or alkoxy group with 4 or more, preferably 4 to 12 C atoms, like 2-methylbutyl, 2-methyloctyl, 2-methylbutoxy or 2-methyloctoxy,
Ch is a chiral group selected from cholesteryl, estradiol, or terpenoid radicals like menthyl or citronellyl,
L is, in case of multiple occurrence independently of one another, H, F, Cl, CN or optionally halogenated alkyl, alkoxy, alkylcarbonyl, alkoxycarbonyl, alkylcarbonyloxy or alkoxycarbonyloxy with 1 to 5 C atoms,
r is 0, 1, 2, 3 or 4,
t is, in case of multiple occurrence independently of one another, 0, 1, 2 or 3,
u and v are independently of each other 0, 1 or 2,
w is 0 or 1,
x and y are independently of each other 0 or identical or different integers from 1 to 12,
z is 0 or 1, with z being 0 if the adjacent x or y is 0,
   and wherein the benzene and napthalene rings can additionally be substituted with one or more identical or different groups L.

The general preparation of polymerised LC or RM films is known to the ordinary expert and described in the literature, for example in D. J. Broer; G. Challa; G. N. Mol, Macromol. Chem., 1991, 192, 59. Typically a polymerisable LC or RM material is coated or otherwise applied onto a substrate where it aligns into uniform orientation, and polymerised in situ in its LC phase at a selected temperature for example by exposure to heat or actinic radiation, preferably by photo-polymerisation, very preferably by UV-photopolymerisation, to fix the alignment of the LC or RM molecules. If necessary, uniform alignment can be further promoted by additional means like shearing or annealing the LC or RM material, surface treatment of the substrate, or adding surfactants to the LC or RM material.

Polymerisation is achieved for example by exposing the polymerisable material to heat or actinic radiation. Actinic radiation means irradiation with light, like UV light, IR light or visible light, irradiation with X-rays or gamma rays or irradiation with high energy particles, such as ions or electrons. Preferably polymerisation is carried out by UV irradiation. As a source for actinic radiation for example a single UV lamp or a set of UV lamps can be used. When using a high lamp power the curing time can be reduced. Another possible source for actinic radiation is a laser, like for example a UV, IR or visible laser.

Polymerisation is preferably carried out in the presence of an initiator absorbing at the wavelength of the actinic radiation. For this purpose the polymerisable LC material preferably comprises one or more initiators, preferably in a concentration from 0 to 5%, very preferably from 0.01 to 1%. For example, when polymerising by means of UV light, a photoinitiator can be used that decomposes under UV irradiation to produce free radicals or ions that start the polymerisation reaction. For polymerising acrylate or methacrylate groups preferably a radical photoinitiator is used. For polymerising vinyl, epoxide or oxetane groups preferably a cationic photoinitiator is used. It is also possible to use a thermal polymerisation initiator that decomposes when heated to produce free radicals or ions that start the polymerisation. Typical radical photoinitiators are for example the commercially available Irgacure® or Darocure® (Ciba Geigy A G, Basel, Switzerland). A typical cationic photoinitiator is for example UVI 6974 (Union Carbide).

The LC or RM material can additionally comprise one or more additives like for example catalysts, sensitizers, stabilizers, inhibitors, chain-transfer agents, co-reacting monomers, surface-active compounds, lubricating agents, wetting agents, dispersing agents, hydrophobing agents, adhesive agents, flow improvers, defoaming agents, deaerators, diluents, reactive diluents, auxiliaries, colourants, dyes, pigments or nanoparticles.

The oriented LC or RM layers and polymer films of the present invention can be used as retardation or compensation film for example in LCDs to improve the contrast and brightness at large viewing angles and reduce the chromaticity. They can be used outside the switchable LC cell in an LCD, or between the substrates, usually glass substrates, forming the switchable LC cell and containing the switchable LC medium (incell application).

The polymer films of the present invention can also be used as alignment film for other LC or RM materials. For example, they can be used in an LCD to induce or improve alignment of the switchable LC medium, or to align a subsequent layer of polymerisable LC material coated thereon. In this way, stacks of polymerised LC films can be prepared.

The LC or RM layers and multilayer films of the present invention can be used as optical retarders or compensators, for example for viewing angle compensation or to provide a certain phase retardation, for example as AQWF.

The LC or RM layers and multilayer films of the present invention can be used in various types of LC displays, for example displays with vertical alignment like the DAP (deformation of aligned phases), ECB (electrically controlled birefringence), CSH (colour super homeotropic), VA (vertically aligned), VAN or VAC (vertically aligned nematic or cholesteric), MVA (multi-domain vertically aligned) or PVA (patterned vertically aligned) mode; displays with bend or hybrid alignment like the OCB (optically compensated bend cell or optically compensated birefringence), R-OCB (reflective OCB), HAN (hybrid aligned nematic) or pi-cell (π-cell) mode; displays with twisted alignment like the TN (twisted nematic), HTN (highly twisted nematic), STN (super twisted nematic), AMD-TN (active matrix driven TN) mode; displays of the IPS (in plane switching) mode, or displays with switching in an optically isotropic phase.

The present invention is described above and below with particular reference to the preferred embodiments. It should be understood that various changes and modifications may be made therein without departing from the spirit and scope of the invention.

Unless the context clearly indicates otherwise, as used herein plural forms of the terms herein are to be construed as including the singular form and vice versa.

Throughout the description and claims of this specification, the words “comprise” and “contain” and variations of the words, for example “comprising” and “comprises”, mean “including but not limited to”, and are not intended to (and do not) exclude other components.

It will be appreciated that variations to the foregoing embodiments of the invention can be made while still falling within the scope of the invention. Each feature disclosed in this specification, unless stated otherwise, may be replaced by alternative features serving the same, equivalent or similar purpose. Thus, unless stated otherwise, each feature disclosed is one example only of a generic series of equivalent or similar features.

All of the features disclosed in this specification may be combined in any combination, except combinations where at least some of such features and/or steps are mutually exclusive. In particular, the preferred features of the invention are applicable to all aspects of the invention and may be used in any combination. Likewise, features described in non-essential combinations may be used separately (not in combination).

It will be appreciated that many of the features described above, particularly of the preferred embodiments, are inventive in their own right and not just as part of an embodiment of the present invention. Independent protection may be sought for these features in addition to or alternative to any invention presently claimed.

The invention will now be described in more detail by reference to the following examples, which are illustrative only and do not limit the scope of the invention.

Above and below, unless stated otherwise percentages are percent by weight and temperatures are given in degrees Celsius.

The following abbreviations are used.

Uₐ=anode potential (V)

j=current density (μA/cm²)

τ=exposure time

α=incidence angle of plasma beam

φ₁₂=angle between in-plane projections of slow axes of the first and the second anisotropic layers in multilayer

φ=analyzer angle in ellipsometry

φ=testing light incidence angle (sample rotation angle) in ellipsometry

φ_{LC}=azimuthal angle of LC

θ_{LC}=polar angle of LC (pretilt angle)

### Example 1

### Preparation of an AQWF

### 1.1 Formation of First RM Layer

The following formulation (formulation 1) is prepared:

### Formulation 1

| | |
|---|---|
| RMM684 | 40.00% |
| Toluene | 60.00% |

RMM684 is a commercially available calamitic RM mixture for planar alignment (from Merck KGaA, Darmstadt, Germany).

Formulation 1 is spin coated at 3000 rpm onto a rubbed polyimide coated glass slide. The sample is annealed at 60° C. for 30 s. After annealing, the sample is polymerised using an EFOS lamp (200 mW/cm²) with the 250-450 nm filter at ambient temperature for 60 s. The retardation profile of the slide is measured using a null ellipsometry [as described in O. Yaroshchuk et al., J. Chem.Phys., 114, 5330 (2001)].

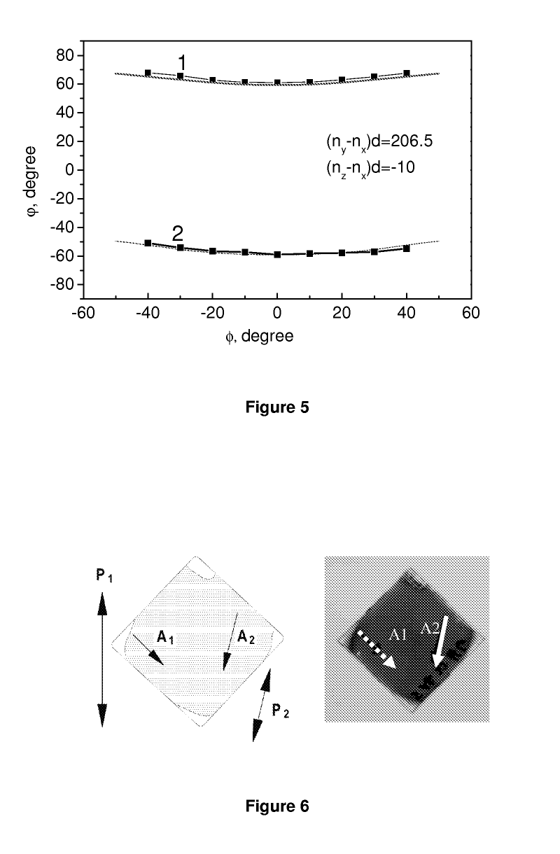

FIG. 5 shows the retardation profile (analyzer angle φ versus sample rotation angle φ) of the polymerised film, wherein the dots represent the measured values. For comparison, the modeled values (solid line) are also shown. Curves 1 and 2 correspond to vertical and horizontal position of the slow axis of the film, respectively. The modeled curves fit well to the experimental data. The in-plane and out-of-plane retardations of the film are 206.5 nm and −10 nm, respectively. These data show that the film has the optical property of a positive A-plate.

### 1.2 Formation of Second RM Layer

The following formulation (formulation 2) is prepared:

### Formulation 2

| | |
|---|---|
| RMM698 | 20% |
| Toluene | 80% |

RMM698 is a commercially available calamitic RM mixture for planar alignment (from Merck KGaA, Darmstadt, Germany).

The first layer of example 1.1 is obliquely processed (etched) by a beam of Ar plasma in the geometry shown in FIG. 2a (α=25°, Uₐ=600 V, τ=3 min, j=6-8 μA/cm²) so that projection of the plasma beam on the sample forms an angle of about 60° with the intrinsic anchoring direction of the first layer.

The processing parameters correspond to alignment mode 1 of an LC layer, wherein the induced LC anchoring direction is parallel to the in-plane projection of the plasma beam (A₂ direction in FIG. 4a). [see O. Yaroshchuk et al., Liq. Cryst., 31, 6, 859-869 (2004)].

Formulation 2 is spin coated at 3000 rpm onto the plasma treated first layer of example 1.1. The sample is annealed at 60° C. for 30 s. After annealing, the sample is polymerised using an EFOS lamp (200 mW/cm²) with a 250-450 nm filter at ambient temperature for 60 s. Optical microscopy shows that the film stack consists of two distinct, well aligned films. By rotating the film stack between crossed polarizers, it is observed that the retardation of the film changes, however at no point a dark state is observed.

FIG. 6 shows a photograph, and its schematical illustration, of the two-layer RM film viewed between two polarizers (polarizer and analyzer), wherein the angle between the two polarizer axes is about 30°. The arrows P1, P2, A1 and A2 mark the positions of polarizer, analyzer, optic axis directions of the first and the second films, respectively. The angle between the two optic axes φ₁₂ is approximately 60°. At these positions a dark state is attained.

That the alignment of RMs in the second film is in A₂ direction (as depicted in FIG. 4b) is confirmed by forming a second film from the mixture RMM698 as described above, but wherein the RMM698 is doped with 3 wt. % of a dichroic azodye.

The above results show that the film obtained by the process of Example 1 is a stack of two A-plates with their slow axis oriented at an angle of about 60° to each other.

### Example 2

### Preparation of an AQWF

A first RM layer is prepared from formulation 1 as described in Example 1 and exposed to a plasma beam in the geometry shown in FIG. 4b so that projection of the plasma beam on the sample forms an angle of about 30° with the intrinsic anchoring direction of the first layer. The set of processing parameters used (α=25°, Uₐ=600 V, j=6-8 μA/cm², τ=20 min) corresponds to induced anchoring direction perpendicular to the plasma beam incidence plane (alignment mode 2) (A₂ direction in FIG. 4b). This means that the induced anchoring direction forms angle of about 60° with the intrinsic anchoring direction of the first RM sub-layer.

A second RM sub-layer of formulation 2 is coated onto the first RM layer as described in Example 1. The optic axis of this film is detected and found to be in the induced anchoring direction, i.e., φ₁₂ is approximately 60°.

### Example 3

### Wide Viewing Angle Compensation Film for TN-LCD Consisting of Two Crossed A Films

The following formulation (formulation 3) is prepared:

### Formulation 3

| | |
|---|---|
| RMM256C | 30% |
| Toluene | 70% |

RMM256C is a commercially available calamitic RM mixture for planar alignment (from Merck KGaA, Darmstadt, Germany).

Formulation 3 is spin coated at 3000 rpm onto a rubbed polyimide coated glass slide. The sample is annealed at 60° C. for 30 s. After annealing, the sample is polymerised using an EFOS lamp (200 mW/cm²) with the 250-450 nm filter at ambient temperature for 60 s. Thereby a first polymerised RM layer is obtained.

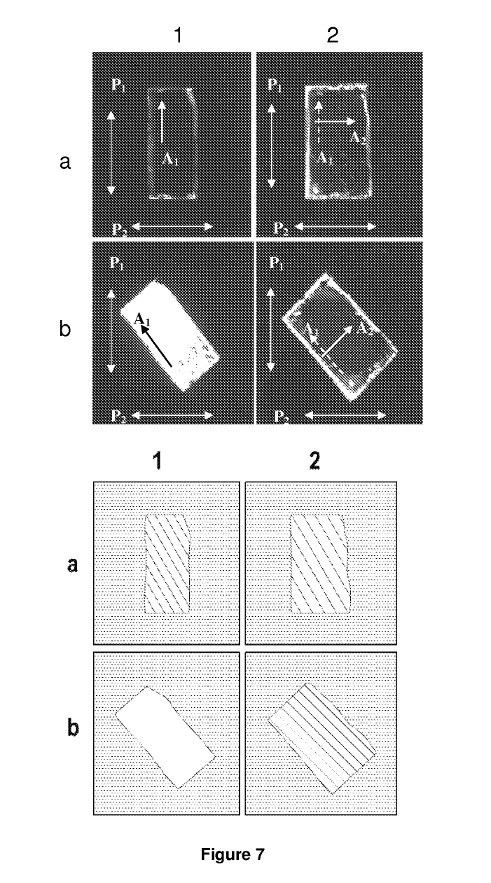

FIG. 7 shows a photograph, and its schematical illustration, of the polymerised first RM layer (1) between two crossed polarizers, wherein in case (a) the optic axis of the first RM layer (A₁) is parallel to one of the polarizers, and in case (b) the optic axis of the first RM layer forms an angle of 45° with the polarizers.

The retardation profile of the first RM layer is measured by ellipsometry and is similar to that for the first layer of Example 1.1 (see FIG. 5). This shows that the first RM layer is a positive A film.

Subsequently, the polymerised first RM layer is exposed to plasma beam (α=25°, Uₐ=600 V, j=6-8 μA/cm², τ=3 min) in the geometry as shown in FIG. 4a, so that the angle between the induced anchoring axis of the first layer and the projection of plasma beam into the film plane is 90°.

A second RM layer of formulation 3 is then coated onto the first RM layer and polymerised as described for the first layer.

Photographs of the obtained two-layer film between two crossed polarizers are schematically illustrated in FIG. 7 (2), wherein in case (a) the optic axis of the first RM layer (A₁) is parallel to one of the polarizers, and in case (b) the optic axis of the first RM layer forms an angle of 45° with the polarizers. It is evident that the in-plane retardation of this film is negligible.

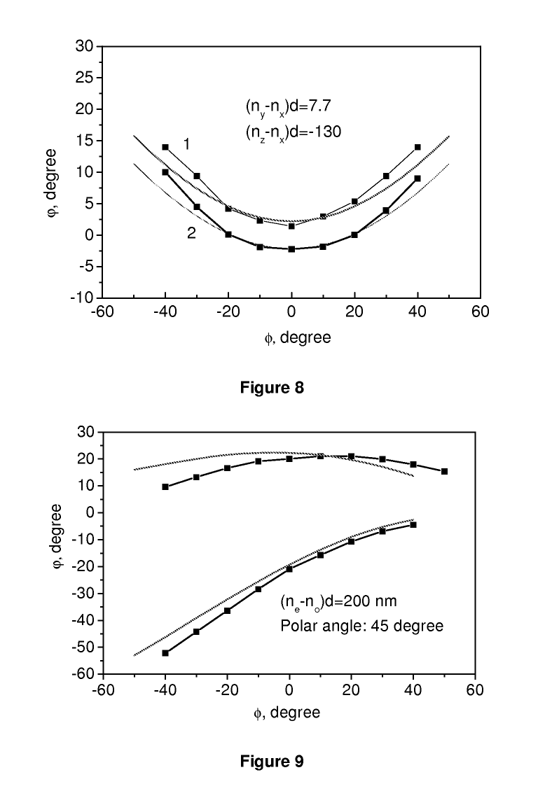

This is also confirmed by the retardation profile shown in FIG. 8, which depicts the measured (dots) and modeled (solid line) analyzer angle φ vs sample rotation angle φ curves of the two-layer film comprising two layers of polymerised RMM256C with crossed optic axes. Curves 1 and 2 correspond to vertical and horizontal position of the slow axis of the first layer (A₁) during measurement, respectively. The modeled curves fit well to the experimental data. The in-plane and out-of-plane retardations of the film are 7.7 nm and −130 nm, respectively. These data show that the two-layer film has the optical property of a negative C plate.

### Example 4

### Wide Viewing Angle Compensation Film for TN-LCD Consisting of Two Crossed O films

The following formulation (formulation 4) is prepared:

### Formulation 4

| | |
|---|---|
| RMM19B | 30% |
| Toluene | 70% |

RMM19B is a commercially available calamitic RM mixture for tilted/splayed alignment (from Merck KGaA, Darmstadt, Germany).

Formulation 4 is coated onto a glass slide that is covered by a plasma beam treated polyimide film providing an anchoring direction A₁. After that the RM film is annealed and polymerised as described in Example 1.

FIG. 9 shows the retardation profile of the polymerised film, including the measured (dots) and modeled (solid line) analyzer angle φ vs sample rotation angle φ curves. Curves 1 and 2 correspond to vertical and horizontal position of the in-plane projection of slow axis. The profile corresponds to that of a typical positive O film, with a polar angle of the slow axis of about 45°.

The surface of the first RM layer is then treated by a plasma beam in the geometry 1 as shown in FIG. 4a, so that the anchoring direction A₂ (corresponding to the in-plane projection of the alignment axis of the second layer) is induced perpendicularly to the in-plane projection of the optic axis of the first layer (direction A₁).

A second RM layer of formulation 4 is then coated onto the first RM layer and polymerised as described for the first layer.

### Comparative Example 1

### RM Layer Provided on a Rubbed RM Layer

### 1. Formation of First RM Layer

Formulation 1 of Example 1 is spin coated at 3000 rpm onto a rubbed polyimide coated glass slide. The sample is annealed at 60° C. for 30 s. After annealing, the sample is polymerised using an EFOS lamp (200 mW/cm²) 250-450 nm filter at ambient temperature for 60 s.

The retardation profile of the slide is measured using a null ellipsometer. The retardation profile of this film is similar to that shown for the first layer in example 1 (see FIG. 5).

The polymerised RM film is then manually rubbed by a velvet cloth using a standard rubbing procedure. The rubbing length is about 25 cm and the rubbing pressure is about 0.15 Ncm⁻². The rubbing direction forms an angle of 45° with the slow axis of the first layer.

### 2. Formation of Second RM Layer

The following formulation (formulation 5) is prepared:

### Formulation 5

| | |
|---|---|
| RMM698 | 29% |
| Disperse Orange 3 | 1% |
| Toluene | 70% |

Formulation 5 is spin coated at 3000 rpm onto the rubbed surface of the first layer. The film formed is annealed at 60° C. for 30 s and then polymerised using an EFOS lamp (200 mW/cm²) 250-450 nm filter at ambient temperature for 60 s.

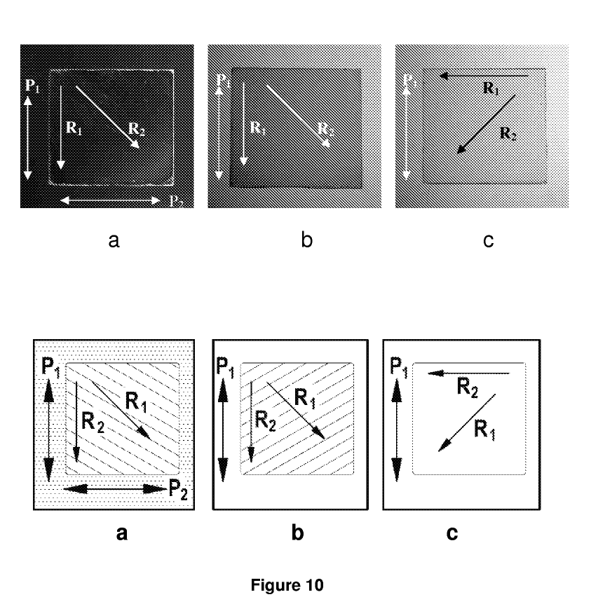

FIG. 10 shows a photograph, and its schematical illustration, of the two-layer film between crossed polarizers (a) and through one polarizer (b, c). The cases (b) and (c) correspond to minimal and maximal light absorption by the dichroic dye in the sub-layer 2. Arrows R₁ and R₂ mark the rubbing directions of the aligning surfaces for the first and the second RM layers, while P₁ and P₂ mark the polarization axes of polarizer and analyzer. In the schematical illustration the labels R₁ and R₂ of the arrows need to be exchanged with each other.

The two-layer film shows clear dark and bright states when rotating between crossed polarizers (FIG. 10a). This implies that the slow axis in the second layer is parallel to the slow axis in the first layer. In other words, the RMs in the second RM layer are aligned in the same alignment direction as the RMs in the first layer rather than in the rubbing direction R₂ (which is 45° to the alignment direction of the first layer). This is fully confirmed by the images of the sample taken in polarized light (FIGS. 10b and 10c), showing that the sample becomes dark when the light polarization direction coincides with the alignment direction in the first layer. This proves that the dichroic dye and hence the RMs in the second layer are aligned in alignment direction of the first RM layer.

This shows that the alignment force imparted by the rubbing process is not strong enough to overcome the alignment force of the RMs of the first layer.

### Example 5

### Multilayer Including Dyed RM Sub-Layer

The layer of formulation 1 (first layer) is deposited on a rubbed polyimide coated glass slide as in Comparative Example 1. The layer is subsequently processed by plasma beam exposure (α=25°, Uₐ=600 V, j=6-8 μA/cm², τ=3 min) in a geometry as shown in FIG. 2a. The in-plane projection of the plasma beam forms an angle 45° with the optic axis of the first layer.

A formulation 5 is coated onto a first layer as described in the step 2 of Comparative Example 1.

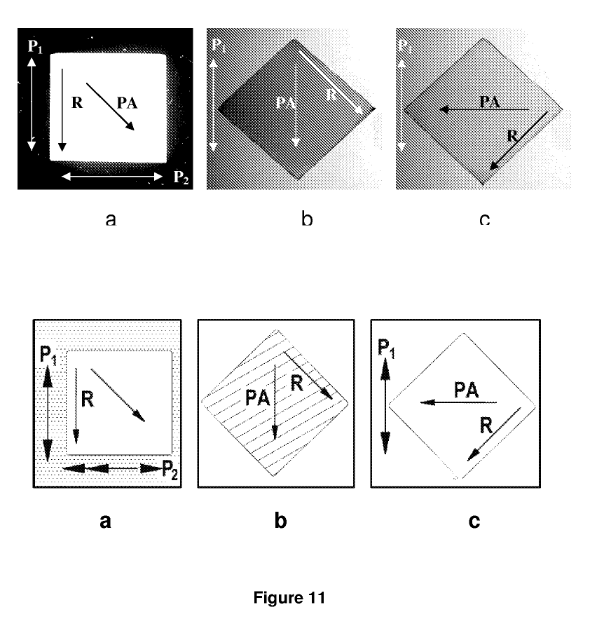

FIG. 11 shows a photograph, and its schematical illustration, of the obtained two-layer film, viewed between crossed polarizers (a) and through one polarizer (b, c). Cases (b) and (c) correspond to minimal and maximal light absorption by the dichroic dye in the second sub-layer. Arrows P₁ and P₂ mark the polarization axes of polarizer and analyzer. Arrows R and PA mark the rubbing direction and plasma treatment direction, respectively. The pictures demonstrate that the RMs in the second layer align in the plasma treatment direction of the first layer (A₂ direction in FIG. 4a, φ₁₂=45°).

This proves that the anchoring of RMs imparted by the plasma beam process overcomes the anchoring of RMs caused by the orientational order of the RM molecules in the first layer, i.e. the alignment force imparted by the plasma process overcomes the alignment force of the RMs of the first layer.

1. Process of preparing a multilayer consisting of at least one first anisotropic layer having an optical axis, and at least one second anisotropic layer of a liquid crystal (LC) material which is optionally a LC polymer or a polymerised LC material, said process comprising the following steps
A) providing a first anisotropic layer having an optical axis,
B) exposing the surface of said first layer to a beam of moderately accelerated particles, thereby providing surface etching and inducing an anchoring direction on said surface of said first layer,
C) providing a layer of LC material onto said exposed surface of said first layer,
D) optionally polymerising said second layer of LC material,
wherein the projection of said optical axis of said first layer into the plane of said first layer forms an angle with the in-plane anchoring direction on said surface of said first layer induced by the particle beam exposure, wherein said angle is different from 0°.

2. Process according to claim 1, characterized in that the first anisotropic layer is a crystal plate, a film of aligned and solidified LC material, a stretched, sheared or photoaligned polymeric layer, or a layer of an LC polymer.

3. Process according to claim 1, characterized in that the multilayer consists of at least one first layer of polymerised liquid crystal (LC) material and at least one second layer of LC material, which is optionally polymerised, and the process comprises the following steps
A) providing a first layer of polymerised LC material having an optical axis,
B) exposing the surface of said first layer to a beam of moderately accelerated particles, thereby providing surface etching and inducing an anchoring direction on said surface of said first layer,
C) providing a second layer of LC material onto said exposed surface of said first layer,
D) optionally polymerising said second layer of LC material,
wherein the projection of the optical axis of said first layer into the plane of the first layer and the anchoring direction on said surface of said first layer, or the projection of the anchoring direction on said surface of said first layer, induced by the particle beam exposure form an angle that is different from 0°.

4. Process according to claim 1, characterized in that the particle beam is a beam of plasma or ions.

5. Process according to claim 1, characterized in that the first and second layer consist of calamitic LCs or RMs.

6. Process according to claim 1, characterized in that the first and second layer consist of discotic LCs or RMs

7. Process according to claim 5, characterized in that LCs or RMs in the first layer have planar, tilted or splayed alignment.

8. Process according to claim 1, characterized in that the LCs or RMs in the second layer have planar, tilted or splayed alignment.

9. Process according to claim 1, characterized in that the optical axis of the first layer or its projection into the plane of the layer, and the optical axis of the second layer or its projection into the plane of the layer, form an angle from 60° to 90° with each other.

10. Process according to claim 1, characterized in that the multilayer comprises more than two layers and the additional layers are deposited by additional steps B), C) and optionally D).

11. Multilayer obtained by a process according to claim 1.

12. Use of a multilayer according to claim 11 as optical retarder or compensator in optical or electrooptical devices.

13. Optical or electrooptical device comprising a multilayer according to claim 11.

14. Device according to claim 13, which is selected from the group consisting of electrooptical displays, liquid crystal displays (LCDs), optical films, polarisers, compensators, beam splitters, reflective films, alignment films, colour filters, holographic elements, hot stamping foils, coloured images, decorative or security markings, LC pigments, adhesive layers, non-linear optic (NLO) devices and optical information storage devices.
